(19) United States
(12) Patent Application Publication
(10) Pub. No.: US 2024/0428580 A1
(43) Pub. Date: Dec. 26, 2024

(54) SYSTEMS AND METHODS FOR AUTOMATED SIDEWALK DEFICIENCY DETECTION

(71) Applicant: North Carolina Agricultural and Technical State University, Greensboro, NC (US)

(72) Inventor: Yuhan Jiang, Stokesdale, NC (US)

(21) Appl. No.: 18/753,573

(22) Filed: Jun. 25, 2024

Related U.S. Application Data
(60) Provisional application No. 63/510,282, filed on Jun. 26, 2023.

(51) Int. Cl. G06V 20/10; G01S 17/88; G06T 7/12; G06T 7/60; G06V 10/70

(52) U.S. Cl. CPC G06V 20/176; G06T 7/12; G06T 7/60; G06V 10/70; G01S 17/88; G06T 2207/10028

(57) ABSTRACT

Methods, systems, and computer readable media for automated sidewalk deficiency detection. In some examples, a method includes obtaining, from a mobile device, a 3D point cloud of a sidewalk section, wherein the sidewalk section includes at least one slab joint; converting the 3D point cloud into one or more elevation images; segmenting, using a machine learning model, the slab joint from the elevation images; determining, based on the segmenting, a vertical displacement of the slab joint; and identifying a potential trip hazard based on the vertical displacement.

### PRIORITY CLAIM

This application claims the priority benefit of U.S. Provisional Patent Application Ser. No. 63/510,282, filed Jun. 26, 2023, the disclosure of which is incorporated herein by reference in its entirety.

### TECHNICAL FIELD

This specification relates generally to methods, systems, and computer readable media for automated sidewalk deficiency detection and mapping.

### BACKGROUND

Public sidewalks are essential infrastructure in cities to provide convenience for urban life. Deficiencies of sidewalks will lead to inconvenience, disruptions and potential hazards to residents. Hence, it is important to monitor and evaluate sidewalk condition such as to take necessary maintenance measures to ensure the normal functionality of sidewalks. To ensure public sidewalks remain in good conditions, local governments usually have their own sidewalk program to assist private property owners (who are the maintaining authority of the sidewalk adjacent to their property) with concrete slab evaluation and defect correction. The typical traditional approach for sidewalk surveying is using smart-level and measuring tools, e.g. tapes, to manually take slope readings and evaluating the compliance with related regulations. However, such manual surveying method takes a long time to assess overall conditions of sidewalks.

Particularly, vertical displacement, also known as vertical fault, is a common concrete slab sidewalk deficiency, which may cause tripping hazards and reduce wheelchair accessibility. To be compliant with Americans with Disabilities Act (ADA), any vertical displacement of new sidewalk concrete slabs (at joints) must be less than 13 mm (½ inches). Local governments have different criteria considering the repair cost and budgets to decide the maintenance actions to take. In general, grinding should be performed to correct the trip hazard, when a joint or crack has a vertical displacement between 13 mm (½ inches) and 3.81 centimeters (1½ inches); otherwise, replacement would be the best method to mitigate trip hazards on public sidewalks. Obviously, manually evaluating sidewalk conditions based on such detailed criteria is very time-consuming and labor intensive. In addition, there is a lack of comprehensive and updated database of sidewalk features and conditions.

TABLE 1
Vertical displacement (changes in level) regulations.

| Sources | Criterion of vertical displacement (changes in level) | Comments |
|---|---|---|
| 2010 ADA | Section 303 Changes in Level | For design |
| Standards for | Changes in level of 6.4 mm (¼ inches) high maximum shall be | and |
| Accessible Design | permitted to be vertical. | construction |
| (Department of | Changes in level between 6.4 mm (¼ inches) high minimum and | |
| Justice, 2010) | 13 mm (½ inches) high maximum shall be beveled with a slope | |
| | not steeper than 1:2. | |
| | Changes in level greater than 13 mm (½ inches) high shall be | |
| | ramped. | |
| (Proposed) Public | R302.7.2 Vertical Surface Discontinuities | |
| Rights-of-Way | Vertical surface discontinuities shall be 13 mm (½ in) maximum. | |
| Accessibility | Vertical surface discontinuities between 6.4 mm (¼ in) and 13 | |
| Guidelines (Access | mm (½ in) shall be beveled with a slope not steeper than 50 | |
| Board, 2013) | percent. | |
| | The bevel shall be applied across the entire vertical surface | |
| | discontinuity. | |
| Sidewalk | At a crack or joint, has a vertical displacement greater than 13 mm | For |
| Deficiencies | (½ inches) height but less than 38.1 mm (1½ inches), the | maintenance |
| Examples, City of | available repair options are: Saw Cut high edge, Mud Jack low | and |
| Middleton, WI | edge, or Replacement. | replacement |
| (City of Middleton, | | |
| 2021a) | | |
| Policy No. 36, | All concrete slabs that have cracks (including control joints) with | For |
| Concrete | differential settlement of greater than 19.05 mm (¾ inches) which | maintenance |
| Replacement | may cause tripping. | and |
| Criteria, Village of | A concrete slab is eligible for grinding to correct a trip hazard(s) if | replacement |
| Shorewood, WI | the vertical displacement is between 19.05 and 38.1 mm (¾ and | |
| (Shorewood | 1½ inches). | |
| Village Board, | This criterion does not require replacement of all concrete | |
| 2019) | sidewalk that does not meet ADA requirements for change in level | |
| | of 6.4 mm (¼ inches) due to the significant amount of sidewalk | |
| | replacement which would be required to meet these criteria. | |

Therefore, automated sidewalk surveying methods are desired to improve surveying efficiency and alleviate manual workloads. Previous studies have proposed using the Ultra-Light Inertial Profiler (ULIP), which is a Segway-based sensor and acquisition system. In addition, ULIPr (which is the RoLine 1130 laser line scan sensor version of ULIP) was designed to capture a 3D representation of the travel surface. Nevertheless, both ULIP and ULIPr have limited coverage of the sidewalk, making them likely to miss the vertical displacement between the sidewalk slabs. Pose estimation sensors such as IMU are also utilized to measure the condition of sidewalks, which however also suffer from the same problem of limited coverage of the object.

### SUMMARY

This document describes methods, systems, and computer readable media for automated sidewalk deficiency detection. In some examples, a method includes obtaining, from a mobile device, a 3D point cloud of a sidewalk section, wherein the sidewalk section includes at least one slab joint; converting the 3D point cloud into one or more elevation images; segmenting, using a machine learning model, the slab joint from the elevation images; determining, based on the segmenting, a vertical displacement of the slab joint; and identifying a potential trip hazard based on the vertical displacement.

The computer systems described in this specification may be implemented in hardware, software, firmware, or any combination thereof. In some examples, the computer systems may be implemented using a computer readable medium having stored thereon computer executable instructions that when executed by the processor of a computer control the computer to perform steps. Examples of suitable computer readable media include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

FIGS. 1A-1D show sidewalk concrete slabs at joint Jᵢⱼ.

FIG. 1E is a block diagram of an example system for automated sidewalk deficiency detection.

FIG. 2A-2D proposed automated trip hazard detection approach.

FIGS. 3A-3D illustrate an example algorithm for joint extraction and vertical displacement measurement.

FIGS. 4A-4B show examples of the mapped joint and trip hazards with annotated image segments.

FIG. 5 is an image showing experimental sidewalk paths.

FIGS. 6A-6B show plots of model training and validation with RGB and RGB+Normal for loss (FIG. 6A) and accuracy (FIG. 6B).

FIGS. 7A-7H show a comparison of segmentation results.

FIGS. 8A-8B show grinding eligible concrete slabs with marked trip hazards.

FIGS. 8C-8D show repaired concrete slabs without marked trip hazards.

FIG. 8E shows a curved sidewalk Path E in good condition with groover cut contraction joints.

FIG. 8F shows a newly constructed sidewalk Path F with sawcut contraction joints.

FIGS. 9A-9C show experimental results of Path C with repaired concrete slabs.

FIGS. 10A-10C show experimental results of Path E with groover cut contraction joints.

FIGS. 11A-11C show experimental results of Path F with sawcut contraction joints.

FIGS. 12A-12B show experimental results of Paths A and B with trip hazards.

FIGS. 13A-13D show experimental results of Path D with different GSDs.

FIGS. 14A-14E show experimental results on Trials 2 and 3 to compare SfM and the proposed method.

FIGS. 15A-15D show images with detected and annotated trip hazards for path P₁, P₂, P₃, and P₄.

FIGS. 16A-16B show mapped joint and trip hazards with annotated image segments and specific information.

### DETAILED DESCRIPTION

This document describes systems configured to automatically detect and geo-visualize sidewalk trip hazards. This document describes example systems with reference to a study on a cost- and time-effective approach that integrates mobile devices, deep learning, and geographic information systems (GIS) in the scanning phase, data processing phase, and trip hazard mapping phase. In the scanning phase, the as-is conditions of sidewalk sections are scanned using mobile devices, in which both low-cost LiDAR (light detection and ranging) scanner (which determines distances by targeting a surface with a laser and measuring the time for the reflected light to return to the receiver) and SfM (structure from motion) photogrammetry (which estimates 3D structures from 2D image sequences) are supported. The example methods and systems are described with respect to a study that was performed on example systems.

In the processing phase, a method is performed to convert the obtained point cloud data to feature images, after which a deep learning-based segmentation model is used for precise concrete slab joint detection, which showed good performances in building and infrastructure defect detection. In addition, this study described a concrete slab joint extraction and vertical displacement measurement algorithm to extract joints from the segmented images of both straight and curved sidewalks with straight and oblique joints. After that, the elevation differences of adjacent slab edges are measured, while the detected trip hazards are marked at the higher edges with wavy lines and the calculated displacement values.

In the mapping phase, sidewalk concrete slab joints are mapped in the Web GIS platform with measured vertical displacement values and attached annotated images. Joints are classified as trip hazard and normal as well. Furthermore, comprehensive experiments were conducted to evaluate the developed sidewalk trip hazard detection and geo-visualization approach in three communities, including University of Wisconsin-Milwaukee (UWM), Shorewood Village, and South Dakota State University (SDSU).

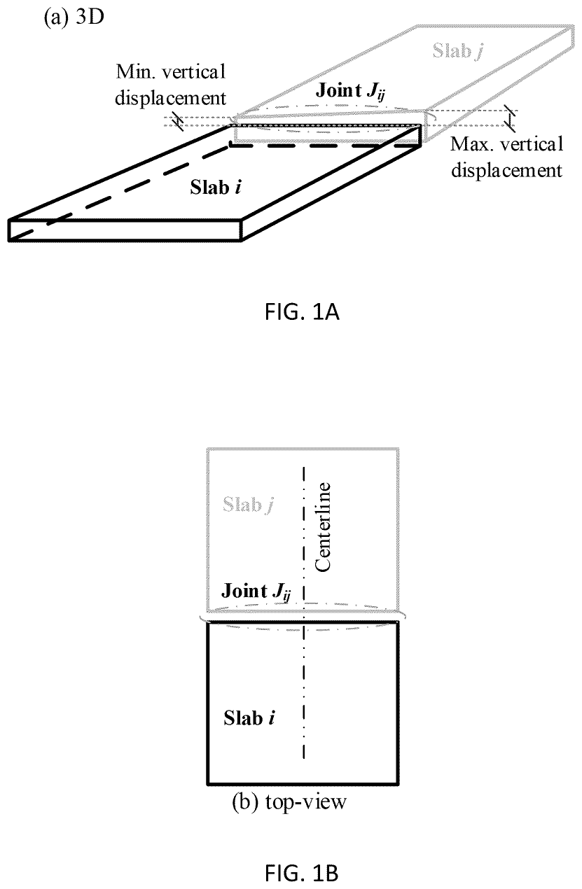

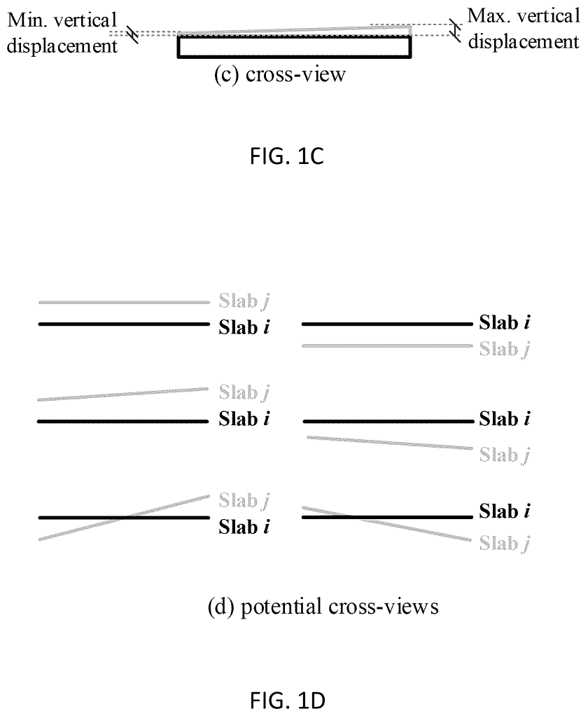

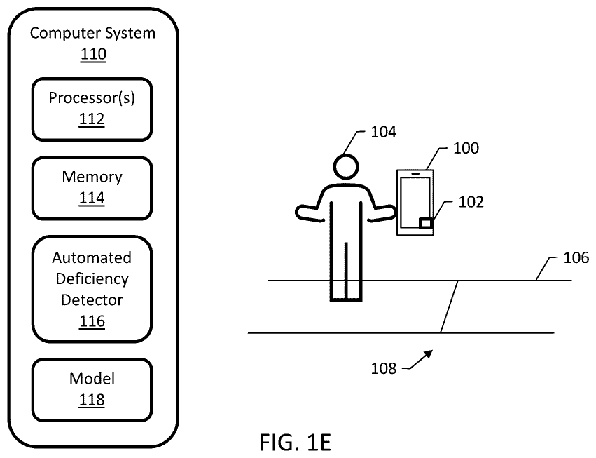

As shown in FIGS. 1A-1D, sedimentation of concrete slabs may cause different vertical displacement along the joint of two adjacent concrete slabs. Thus, the walked path- and travel surface-based approaches would skip the maximum vertical displacement when it is located at the end of a joint like the bottom four conditions shown in FIG. 1D. To evaluate the elevation of the sidewalk in full-width coverage, 3D dense point clouds can potentially provide more comprehensive and accurate information. One method for sidewalk scanning is directly obtaining point cloud using laser scanning (LiDAR) while another is reconstructing 3D point cloud from images or videos using 3D reconstruction approaches such as SfM photogrammetry.

However, SfM photogrammetry requires much more time in sidewalk scanning and point cloud acquisition due to two main reasons: (a) highly overlapped high-resolution images are essential raw data for SfM, which needs the camera to remain a small distance away from sidewalk surfaces, and slowly move over multiple paths to guarantee overlaps and full coverage; (b) image processing and 3D reconstruction are slowed down due to the number of images, for example, cloud processing one hundred images needs approximately 50 to 70 minutes by Autodesk ReCap Photo, which may need additional time for waiting in the queue before the processing. In contrast, LiDAR can obtain dense point clouds for the scanned object immediately. It is the most effective technique for capturing 3D reality data if its price drops down. Fortunately, LiDAR sensors are built-in components for some relatively low-cost mobile deceives such as iPad Pro and iPhone Pro. Thus, this study utilized and tested the low-cost LiDAR scanner for sidewalk as-is condition scanning while the SfM photogrammetry was tested for sidewalk scanning with a mobile phone without LiDAR sensor as well.

### Infrastructure Defect Detection and Assessment Using Deep Learning

The sidewalk (concrete slabs) surfaces are similar to the roadway pavement surfaces, both of which are relatively flat planes. It is feasible to simplify (convert) a 3D point cloud to a 3D image to represent the elevation feature of the sidewalk concrete slab surface. In addition, the corresponding 2D image, e.g., top-view and drone photogrammetric orthophoto, can provide the spectral features (Red, Green, Blue) at the same pixel coordinates.

To evaluate defects and structure condition, one method is to precisely extract boundaries of target objects (e.g., cracks). The U-Net can reach a higher accuracy with fewer training data sets of images and labels and has a good performance in thin cracks detection. Hence, U-Net was used as an example segmentation model in this study.

In concrete slabs, temperature changes can result in concrete expanding or shrinking, thus joints are commonly designed and created by forming, tooling, sawing, and placing joint formers to prevent cracks when the concrete shrinks. Sidewalk concrete slab joints can be classified as contraction (control) joint, isolation (expansion) joint, and construction joint. They are normally in a straight-line shape, as shown in FIG. 1B, ranging from 3 mm to 20 mm with different creating methods. As joints have similar features as cracks, the example methods and systems used a deep learning-based segmentation model (e.g. U-Net) for sidewalk joint detection and segmentation.

FIG. 1E is a block diagram of an example system for automated sidewalk deficiency detection. The system includes a mobile device 100 (e.g., a mobile phone, tablet, or laptop computer) that includes a LiDAR scanner 102. A user 104 carries the mobile device 100 over a sidewalk section 106 including at least one slab joint 108, e.g., a concrete slab joint, while the mobile device 100 scans the sidewalk section 106 with the LiDAR scanner 102.

The system includes a computer system 110 including one or more processors 112 and memory 114 storing instructions for the processors 112. The computer system 110 can be implemented on the mobile device 100 or on a remote computer system, e.g., in a cloud computing system, or a combination of the mobile device 100 and a remote computer system.

The computer system 110 includes an automated deficiency detector 116 configured for obtaining a 3D point cloud of the sidewalk section 106; converting the 3D point cloud into one or more elevation images; segmenting, using a machine learning model 118, the slab joint 108 from the elevation images; determining, based on the segmenting, a vertical displacement of the slab joint 108; and identifying a potential trip hazard based on the vertical displacement.

### Automated Trip Hazard Detection Approach

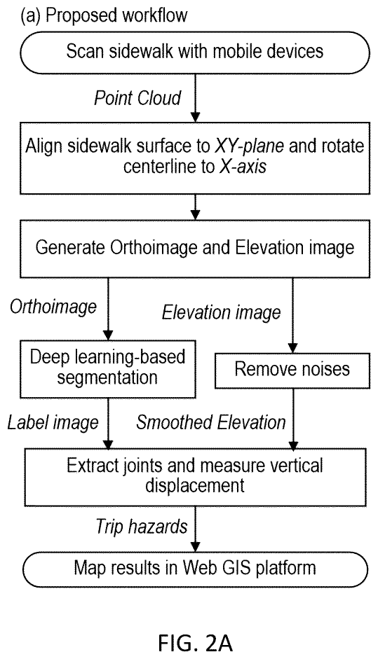

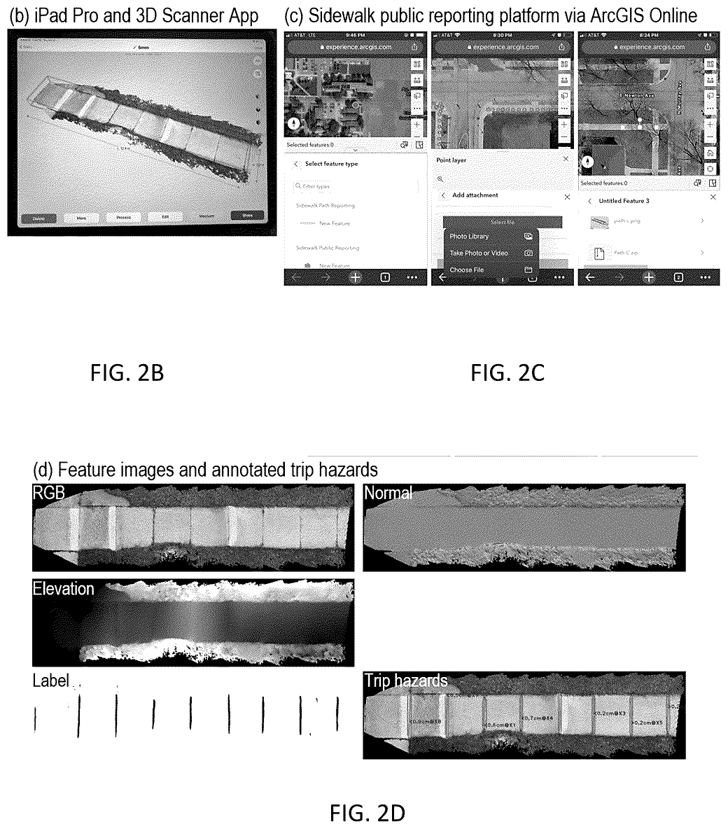

FIG. 2A presents the procedure of the example method. There are four main steps involved in the process, including (1) sidewalk scanning using mobile devices and feature image generation, (2) deep learning-based image segmentation, (3) joint extraction and vertical displacement measurement, and (4) trip hazard mapping and geo-visualization in the, e.g., Web GIS platform.

### Sidewalk Scanning and Feature Image Generation

Mobile devices such as iPad Pro (or iPhone Pro) with LiDAR sensor are used for scanning sidewalks in this study to obtain the point cloud data. A 3D scanning tool such as the 3D Scanner App is used to acquire the 3D point cloud of the sidewalk in real-time. Table 3 lists the parameters of the high-resolution mode of 3D Scanner App used in this study. After scanning, the data will be processed to generate the textured point cloud in the 3D Scanner App (e.g., FIG. 2B). Then, the point cloud can be exported as a LAS file. The 3D Scanner App is just one example application that can be employed. Other examples of other applications that can be used to generate the 3D point cloud include but are not limited to the iPhone/iPad 3D scanner and the Apple 3D scanning API. These applications are available, for example, on the Apple App Store.

Moreover, this study proposed a sidewalk public reporting platform via a Web GIS system (i.e. ArcGIS online) for property owners or concerned citizens to report sidewalk trip hazards with their surveyed results. Users can place start and end points, paths, and regions to mark the scanned sidewalks in the reporting platform, where location service is enabled to fast and accurately find the user's current location as shown in the left screenshot of FIG. 2C. The scanned files can be uploaded to the reporting platform as shown in the right two screenshots of FIG. 2C. As a result, the local governments can easily review the reported cases and assign teams to inspect or repair the concrete slabs.

TABLE 3
Parameters of scanning.

| Parameters | Options | Instructions by (Laan Labs, 2021) | This paper |
|---|---|---|---|
| Confidence | [Low, Medium, | Options for thresholding the data coming in from | Medium |
| | High] | the sensor. [High] only keeps the best quality data, | |
| | | but reduces the amount of data available. | |
| Range | 0.3 m to 5.0 m | Discards LiDAR data after a certain distance. | 3.0 m |
| | | Limiting range reduces scan size and increases | |
| | | accuracy. | |
| Resolution | 5 mm to 20 mm | Lower values mean higher resolution, but also | 10 mm and 5 mm |
| | | limited scan size. | |
| Masking | [None, Object, | This feature masks LiDAR data based on the type | None |
| | Person] | of object in view. [Object] attempts to isolate | |
| | | prominent objects in view. For best results, keep | |
| | | the object fully in view, and use on a simple | |
| | | background without other clutter in view. | |
| Point cloud | [Low, Medium, | Allow the model to be shared as USDZ, GLB, | High density |
| export | High] | GLTF, OBJ, DAE, STL, Point Cloud, or to | LAS file. |
| | | Sketchfab. | |

Following that, a pointcloud2orthoimage algorithm and tool can be configured to automatically convert a sidewalk point cloud to feature images, e.g., orthoimage and elevation image, see FIG. 2D. The algorithm has the following key processes: (a) Find a plane in the point cloud (in general, the plane contains most of the sidewalk surface points); (b) Calculate the rotation angle between the normal and Z-axis of the plane, and use the angle to rotate the point cloud such as to align the sidewalk surface with the XY-plane; (c) Find an oriented bounding box for the point cloud (with a rotation matrix R), and use the inverse matrix R⁻¹ to rotate the point cloud and make the sidewalk centerline codirect to the X-axis; and, (d) Translate the point cloud and make its center close to (0,0,0) if necessary. The developed tool utilized the plane segmentation and oriented bounding box functions in Open3D to obtain geometry information The generated point cloud feature images have unlimited size, which means any scanned long sidewalk can be presented in a continuous high-resolution image. Meanwhile, the differently sized RGB feature images also have the same geospatial resolution, known as ground sampling distance (GSD).

### Deep Learning-Based Image Segmentation

After generating sidewalk feature images, a deep learning model was proposed for pixelwise segmentation of sidewalk joints in the image. During model training and prediction stages, a disassembling and assembling algorithm was used because the dimension of a feature image may be too large to be processed by a workstation. Specifically, the algorithm first disassembled a large-resolution feature image into multiple small-patches with a dimension of 128×128-pixel, each of which overlaps 50% with the adjacent small-patches in both width and height directions. Then, the disassembled small-patches were fed into the deep learning segmentation model rather than directly using the large-resolution input, and correspondingly small-patch outputs would be generated by the model with segmented labels. In the end, the small-patch outputs were assembled to produce a segmented image with the same dimension as the original input image.

After segmentation, the 1-channel segmented label image has a pixel value range of 0 to 255 which is obtained by multiplying 255 with the results of Sigmoid (i.e. the activation function in the end layer of the segmentation model), which are in the range of 0 to 1. Then, any pixel with a value less than the threshold (which is 255/2=127) was updated to 0 to indicate the joint, otherwise, replaced with 255 to represent non-joint objects. As a result, the trained model can be utilized for label image generation (i.e. segmentation) for large-resolution feature image inputs as shown in FIG. 2D.

### Joint Extraction and Vertical Displacement Measurement

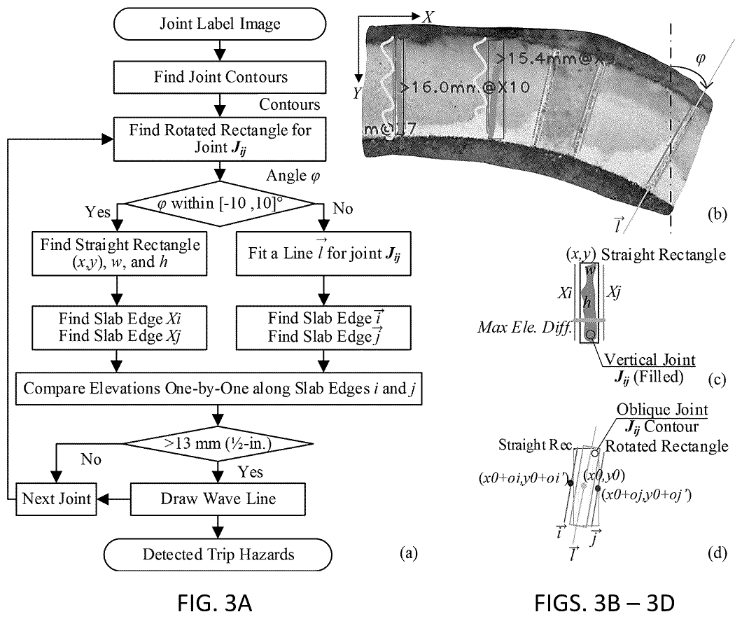

Typically, sidewalk concrete slabs are in a rectangular shape, and joints are perpendicular to the sidewalk centerline as shown in FIG. 1B. Once the sidewalk path is rotated into the horizontal direction, the joints are in vertical directions in the feature image as shown in FIG. 2D. In addition, the special case of a curved sidewalk is shown in FIG. 3B, where joints are perpendicular to the centerline, while oblique joints have an angle φ to the vertical direction. An example of vertical (straight) joint and oblique joint is illustrated in FIG. 3C and FIG. 3D respectively. To accurately measure the vertical displacement between adjacent concrete slabs, this study proposed a joint extraction and vertical displacement measurement algorithm to process both vertical (straight) joints and oblique joints. Details of the example algorithm are shown in FIG. 3A.

Table 4 summarizes the parameters of the proposed algorithm, which uses a joint label image as input. Since joints are scatter instances in the label image, edges of joints are easy to determine as contours. Then, the ensuing steps and geometry information as follows are used to process a joint Jᵢⱼ.

(1) Find a rotated bounding rectangle for the extracted joint contour Jᵢⱼ, where a center of (x0, y0) and an angle φ (compared to the vertical direction) are returned (see FIG. 3B).

(2a) If angle φ falls in a range of [−10°,10° ], the joint is classified as a vertical joint. Find a straight bounding rectangle for joint Jᵢⱼ, which has the top-left corner (x, y), width w and height h (see FIG. 3C).

(2b) If the absolute value of angle φ is larger than 10°, the joint is classified as an oblique joint. Fit a line \vec{l} for the joint Jᵢⱼ, and also find a straight bounding rectangle for joint Jᵢⱼ (see FIG. 3D). The fitted straight line would pass through the joint, and have the minimum sum of distances to all points of the joint.

(3a) For an approximate vertical joint Jᵢⱼ, the concrete slab edges i and j are set as two-line segments with an offset to the straight rectangle (offset=3−pixel) and have the pixel length of h−20 (see FIG. 3C).

(3b) For an oblique joint Jᵢⱼ, with a large φ, the concrete slab edges \vec{i} and \vec{j} are codirected to the line \vec{l}, and have the middle point (x0+oi, y0+oi′) and (x0+oj, y0+oj′), respectively (see FIG. 3D), where [oi, oi′, oj, oj′] are small values designed to offset slab edges from the fitted line of the oblique joint Jᵢⱼ. For example, assume (Vx, Vy) is the normalized vector collinear to the line \vec{l}, if Vy/Vx>0, set them as [−6, 3, 6, −3], or if Vy/Vx<0 (in FIG. 3D), set them as [−6, −3, 6, 3].

(4) For a given (X, Y), calculate elevation difference of the corresponding points on the two slab edges. Elevations of points can be obtained from the corresponding elevation image based on pixel coordinates of points. If the maximum elevation difference exceeds the vertical displacement criterion of 13 mm (½ inches), then fill joint Jᵢⱼ (like FIG. 3C) and annotate the maximum elevation difference at the corresponding location with a numerical value and a wavy line to create the annotation of trip hazards in the image like FIG. 3B.

TABLE 4
Parameters of the proposed algorithm for joint extraction and vertical displacement
measurement.

| Parameter | Definition | Comments |
|---|---|---|
| (X,Y) | Pixel coordinate, origin is top-left | Horizontal axis X has positive direction in the right. Vertical axis |
| | corner of a feature image. | Y has positive in downward. |
| φ | Angle of joint Jᵢⱼ direction, positive | An approximate straight joint Jᵢⱼ has −10° ≤ φ ≤ 10°; An oblique |
| | in clockwise | joint Jᵢⱼ has φ < −10° or φ > 10° |
| (x, y) | Coordinate of top-left corner of a | A straight bounding box that contains all pixels for a joint Jᵢⱼ. |
| | straight bounding box. | |
| w, h | Width and height of a straight | |
| | bounding box | |
| $\{ \begin{matrix}Xi \\ Y\end{matrix} , \{ \begin{matrix}Xj \\ Y\end{matrix}$ | Edges of left and right concrete slabs i and j around a joint Jᵢⱼ | $Left slab edge \{ \begin{matrix}Xi = x - 3 \\ y + 10 < Y < y + h - 10\end{matrix} ; Right slab edge \\ \{ \begin{matrix}Xj = x + w + 3 \\ y + 10 < Y < y + h - 10\end{matrix} ; where 3 is used to offset the bounding$ |
| | | box edges; and 10 is used to offset the sidewalk edges to avoid |
| | | measuring vegetation. |
| \vec{l} | Line of an oblique joint Jᵢⱼ, which | Joint Jij has a center (x0, y0), and a normalized vector (Vx, Vy), |
| | has the equation (Y − y0)/(X − x0) = | which is the normalized vector collinear to the line \vec{l}. |
| | Vy/Vx | |
| \vec{i} | Line of left slab edge, which is | Left slab edge has a center (x0 + oi, y0 + oi'), right slab edge has |
| | parallel to \vec{l} | a center (x0 + oj, y0 + oj'), and X has a range of (−L/2, L/2), |
| \vec{j} | Line of right slab edge, which is | where oi, oi', oj,and oj' are small values used to offset slab edges |
| | parallel to \vec{l} | from the joint fitted line \vec{l}, and L = \sqrt{b² + w²}. |

Additionally, to automatically execute the proposed algorithm, image processing techniques are utilized to extract all individual concrete slab joints in a pixelwise segmented label image, as well as the contour features of straight bounding rectangle and rotated rectangle. Following that, the geometry information (e.g. center point, width, height, etc.) of joints is obtained by fitting functions (e.g. “fitting a line”) based on the extracted contours.

### Trip Hazards Mapping and Geo-Visualization

To better visualize and manage the potential trip hazards, a method was proposed to map the detection results (joints and vertical displacements) to a Web GIS platform. The method was based on the image with annotated trip hazards and GPS coordinates of the scanning starting and ending point. If the sidewalk path is arbitrarily scanned, there are two scenarios for the sidewalk, including: Scenario 1, sidewalk (nearly) along the west-east direction, which has a longitude difference i.e. |Longitude_{end}−Longitudeₛₜₐᵣₜ| larger than the latitude difference i.e. |Latitude_{end}−Latitueₛₜₐᵣₜ|; and, Scenario 2, sidewalk (nearly) along the south-north direction, which has a latitude difference larger than the longitude difference. In addition, by considering orders of the scanning start and end points, the two scenarios can be classified into four cases, including: Case1, scan in West-East direction; Case 2, scan in East-West direction; Case 3, scan in South-North direction; and Case 4, scan in North-South direction. The corresponding case is determined by comparing the longitude and latitude GPS coordinates of the start and end points. Then, GPS coordinates of trip hazards and sidewalk joints are determined using equations as follows.

For Case 1 (West-East), the GPS coordinates of a joint Jᵢⱼ can be determined via Eq. (1a),

$$\{ \begin{matrix}{Longitude}_{{J}_{ij}} \\ {Latitude}_{{J}_{ij}}\end{matrix} = \qquad ( 1 a )$$

$$\{ \begin{matrix}{Longitude}_{start} + ( {Longitude}_{end} - {Longitude}_{start} ) \times {ratio}_{x} \\ {Latitude}_{start} + ( {Latitude}_{end} - {Latitude}_{start} ) \times ( {ratio}_{x} - 0.5 + 1 - {ratio}_{y} )\end{matrix}$$

For Case 2 (East-West), the GPS coordinates of a joint Jᵢⱼ can be determined with Eq. (1 b),

$$\{ \begin{matrix}{Longitude}_{{J}_{ij}} \\ {Latitude}_{{J}_{ij}}\end{matrix} = \qquad ( 1 b )$$

$$\{ \begin{matrix}{Longitude}_{start} + ( {Longitude}_{end} - {Longitude}_{start} ) \times {ratio}_{x} \\ {Latitude}_{start} + ( {Latitude}_{end} - {Latitude}_{start} ) \times ( {ratio}_{x} - 0 \text{.5} + {ratio}_{y} )\end{matrix}$$

For Case 3 (South-North), the GPS coordinates of a joint Jᵢⱼ can be determined with Eq. (1c)

$$\{ \begin{matrix}{Longitude}_{{J}_{ij}} \\ {Latitude}_{{J}_{ij}}\end{matrix} = \qquad ( 1 c )$$

$$\{ \begin{matrix}{Longitude}_{start} + ( {Longitude}_{end} - {Longitude}_{start} ) \times ( {ratio}_{x} - 0 \text{.5} + {ratio}_{y} ) \\ {Latitude}_{start} + ( {Latitude}_{end} - {Latitude}_{start} ) \times {ratio}_{x}\end{matrix}$$

And for Case 4 (North-South), the GPS coordinates of a joint Jᵢⱼ can be determined with Eq. (1d),

$$\{ \begin{matrix}{Longitude}_{{J}_{ij}} \\ {Latitude}_{{J}_{ij}}\end{matrix} = \qquad ( 1 d )$$

$$\{ \begin{matrix}{Longitude}_{start} + ( {Longitude}_{end} - {Longitude}_{start} ) \times ( {ratio}_{x} - 0.5 + 1 - {ratio}_{y} ) \\ {Latitude}_{start} + ( {Latitude}_{end} - {Latitude}_{start} ) \times {ratio}_{x}\end{matrix}$$

where,

$$\{ \begin{matrix}{ratio}_{x} \\ {ratio}_{y}\end{matrix} = \{ \begin{matrix}x 0 / Image Width \\ y 0 / Image Height\end{matrix} , \qquad ( 1 e )$$

and (x0, y0) are pixel coordinates of the middle points of joint Jᵢⱼ (see FIG. 3D).

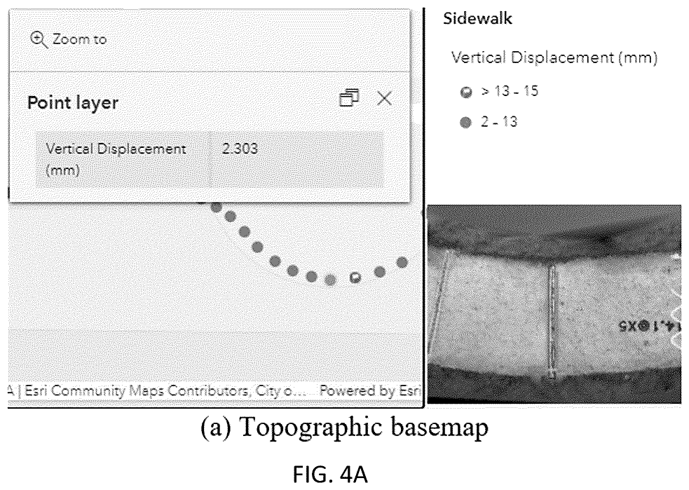

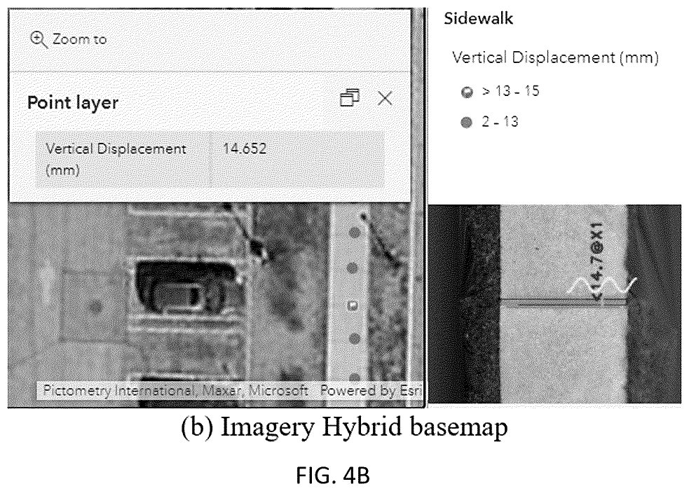

After obtaining the coordinates of trip hazards and sidewalk joints, Web GIS platform is utilized to geo-visualize the sidewalk assessment results, in which sidewalk concrete slab joints are mapped in a point layer with the longitudes and latitudes GPS coordinates of joints that are determined by Eqs (1a, b, c, and d). Point objects are classified as trip hazards and normal sidewalk joints with different labels while the values of vertical displacement are linked with each point object. In addition, cropped segments of the annotated sidewalk trip hazard and joint images are attached to all points, like in FIGS. 4A-4B, where a cropped sidewalk segment is centered at the middle point of joint Jᵢⱼ. As the sidewalk centerline is along the horizontal direction in the sidewalk trip hazards image, the cropped segment needs to rotate 0° for Case 1, rotate 180° for Case 2, rotate 90° for Case 3, and rotate 270° for Case 4 in counterclockwise. Consequently, the rotated segment presents the sidewalk in the correct direction.

### Experimental Results and Discussions

Experiments were performed to validate the feasibility of the proposed approaches, including the concrete slab joints segmentation with deep leaning model, the algorithm for joint extraction and vertical displacement measurement, as well as trip hazard detection and mapping.

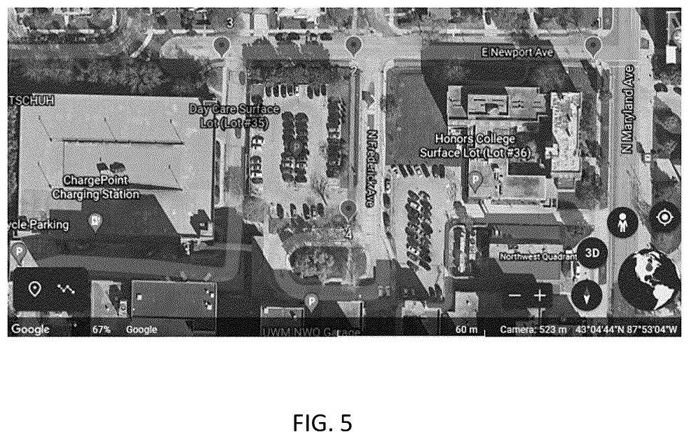

To validate the proposed approach, four sidewalk paths (i.e., P₁, P₂, P₃, P₄, see FIG. 5) on the UWM campus were scanned using an iPad Pro (12.9-in., 4th generation, with a built-in LiDAR sensor) to prepare the model training and testing dataset.

The scanning was conducted with a resolution of 10 mm and other setting in Table 3, and a textured point cloud is generated by a processing tool (3D Scanner App). Then, it is necessary to check the start and end points of the scanned sidewalk and the obtained point cloud, especially when the sidewalk path is long, because part of the point cloud may be lost due to technique issues of the point cloud processing tool. Thus, the following strategies are proposed to obtain geocoordinates for the scanned sidewalk paths:

(1) Place features of points, lines, or polygons to annotate the scanning start and end points, path, or region in the sidewalk public reporting platform by users (see FIG. 2(c)), and the scanned files also could be attached. The alternative option is taking two photos on the scanned sidewalk at the start and end points with a smart phone. The GPS coordinates of the start and end points are recorded in the two images. As a result, the GPS coordinates can be extracted from image properties, and used to improve the automatic level of trip hazard mapping.

(2) Scan an entire sidewalk path (ending with corners or turning points) in a single scanning if possible. Turning points can be manually located on the aerial imagery basemap in the Web GIS if GPS coordinates are not recorded or not accurately recorded during the scan.

(3) Plan breaking points before the scanning if breaks are necessary. Breaking points should be on or next to noticeable reference objects, such as sidewalk intersections, isolated trees, building corners and entrances. Those reference objects should be easy to manually locate on the aerial imagery basemap in the Web GIS as well.

### Feature Image Generation

The obtained point clouds were exported as LAS files and imported into a point cloud processing tool, Autodesk ReCap, for visualization and sidewalk plane alignment (in case the scanned sidewalks have a noticeable slope). By setting the display point size as 2, the orthographic view is close to true orthoimages with few gaps in sparse point regions. Then, sidewalk feature images, including orthographic views of RGB and normal features for the aligned point clouds, were created via screenshot. As a point cloud was kept in the same viewpoint and zoom scale, the captured screenshots of RGB and normal views have the same pixel coordinates. Examples of sidewalk feature images are shown in FIG. 2D, where the RGB view shows points with camera captured colors, and the Normal view displays normal vectors of points in color.

In some examples, the system generates integrated feature images. Specifically, the 6-channel integrated feature images were generated by assembling RGB and Normal information, which have R, G, and B color information in the first three channels, and the normal information in the following three channels. The elevation image was not used for integrated feature image creation because elevations may change along the joint as shown in FIG. 1. In the experiment, segmentation performance was compared for models trained with RGB and RGB+Normal features respectively to investigate whether adding the normal feature can improve the sidewalk concrete slab joint detection. To prepare the groundtruth annotation for the segmentation task, binary pixelwise joint label images were manually created via a labeling tool. When preparing the groundtruth labels, only the concrete slab joints that are perpendicular to the sidewalk centerlines were created by assigning a label value of 0 for joint pixels and a label value of 255 for non-joint pixels.

### Training and Validation Data

In the examples describe in this document, two west-east direction sidewalk paths, P₁ and P₂, were used for model training, in which only up-down joints were labeled (while data of P₃ and P₄ are only for testing the trained model). To enrich the training dataset, the following data augmentation (DA) strategies were conducted in preparing the 128×128-pixel training images and labels. (a) Randomly flip feature image and label in one of the following options: horizontal, vertical, both horizontal and vertical, non-flipping. (b) Randomly resize the flipped feature image and label in the range of [0.5,2.5]. (c) Randomly rotate the resized feature image and label in the range of [−30,30] degrees. (d) Either randomly conduct the perspective transformation of the feature image and label (keep left, right, top, or bottom edge the same), or not. (e) Cut black margins from the transformed feature image and label, and pad the remaining feature image and label to be multiples of 128 pixels. (f) Randomly adjust the padded feature image's brightness, color, contrast, or sharpness in the range of [0.5, 1.5], adjustments are not applied to the normal feature and label. (g) Rotate the adjusted feature image and label by 0° and 180° (because sidewalk paths are always rotated in a horizontal direction, and only joints perpendicular to the centerline are considered in this paper). (h) Crop the two sets of rotated feature images and labels into 128×128-pixel small-patches (which have 50% overlap among adjacent ones) by moving a 128×128-pixel slide window with a stride of 64-pixels in both width and height directions, skipping blank windows.

By repeating the above DA steps with several rounds (skipping the random processing steps in the first round to keep the original feature image and label, and then, runs all steps for remaining times), the created model training data sets would have a high variety of size, shape, color, orientation, and views of concrete slabs and joints. This study ran the DA for 51 rounds and generated 80,806 RGB (3-channel) and ground truth label samples, which were temperately saved in the RAM. Since the RGB+Normal sample is larger than the RGB sample, a fewer number of round DA (i.e., 41 rounds) was applied, which generated 62,284 RGB+Normal (6-channel) and label samples (see Table 5).

TABLE 5
Training and validation data for the segmentation model

| Dataset | RGB | RGB + Normal |
|---|---|---|
| Training | 72,725 | 56,055 |
| Validation | 8,081 | 6,229 |
| Total | 80,806 | 62,284 |

### Training and Testing Results of the Segmentation Model

After preparing the dataset, the U-Net models were constructed with software packages of Keras 2.3.1, Python 3.6.8, OpenCV 3.4.2 and TensorFlow-GPU 1.14, and ran on a workstation of 96 GB RAM and 4×11 GB GPUs for model training. With a 128×128-pixel RGB sample, the detailed U-net model layers and output shapes are shown in Table 6, where the hidden layers “conv2d_1” to “conv2d_23” (kernel size 3×3) use an activation function ReLU for faster model training; the two dropout layers are used to prevent overfitting; the four concatenate layers are used to combine the feature-maps (tensors) from two different layers as a new feature-map (tensors); and the output layer “conv2d_24” (kernel size 1×1) uses the Sigmoid activation function to create label pixels in the range of 0 to 1. Similarly, for any RGB+Normal sample, the output shape of the “input_1” layer is (128, 128, 6), and the parameter number of the “conv2d_1” layer is 3520, and the remaining shapes and parameter numbers are the same as Table 6.

In some examples, the Adam optimizer (learning rate 0.0001) and binary cross-entropy loss function can be used. In this example, each model was set to be trained up to 100 epochs, batch size was set as 256. In addition, 10% of samples were randomly selected to validate the model in each training epoch. Meanwhile, early stopping criteria was used to avoid model overfitting, which would stop the model training once the validation loss does not decrease for 10 epochs.

TABLE 6
U-Net model layers and output shapes.

| | | Parameter | |
|---|---|---|---|
| Layer (type) | Output shape | number | Connected to |
| input_1 (InputLayer) | (128, 128, 3) | 0 | |
| conv2d_1 (Conv2D) | (128, 128, 64) | 1792 | input_1 |
| conv2d_2 (Conv2D) | (128, 128, 64) | 36928 | conv2d_1 |
| max_pooling2d_1 | (64, 64, 64) | 0 | conv2d_2 |
| (MaxPooling2D) | | | |
| conv2d_3 (Conv2D) | (64, 64, 128) | 73856 | max_pooling2d_1 |
| conv2d_4 (Conv2D) | (64, 64, 128) | 147584 | conv2d_3 |
| max_pooling2d_2 | (32, 32, 128) | 0 | conv2d_4 |
| (MaxPooling2D) | | | |
| conv2d_5 (Conv2D) | (32, 32, 256) | 295168 | max_pooling2d_2 |
| conv2d_6 (Conv2D) | (32, 32, 256) | 590080 | conv2d_5 |
| max_pooling2d_3 | (16, 16, 256) | 0 | conv2d_6 |
| (MaxPooling2D) | | | |
| conv2d_7 (Conv2D) | (16, 16, 512) | 1180160 | max_pooling2d_3 |
| conv2d_8 (Conv2D) | (16, 16, 512) | 2359808 | conv2d_7 |
| dropout_1 (Dropout) | (16, 16, 512) | 0 | conv2d_8 |
| max_pooling2d_4 | (8, 8, 512) | 0 | dropout_1 |
| (MaxPooling2D) | | | |
| conv2d_9 (Conv2D) | (8, 8, 1024) | 4719616 | max_pooling2d_4 |
| conv2d_10 (Conv2D) | (8, 8, 1024) | 9438208 | conv2d_9 |
| dropout_2 (Dropout) | (8, 8, 1024) | 0 | conv2d_10 |
| up_sampling2d_1 | (16, 16, 1024) | 0 | dropout_2 |
| (UpSampling2D) | | | |
| conv2d_11 (Conv2D) | (16, 16, 512) | 2097664 | up_sampling2d_1 |
| concatenate_1 | (16, 16, 1024) | 0 | dropout_1, |
| (Concatenate) | | | conv2d_11 |
| conv2d_12 (Conv2D) | (16, 16, 512) | 4719104 | concatenate_1 |
| conv2d_13 (Conv2D) | (16, 16, 512) | 2359808 | conv2d_12 |
| up_sampling2d_2 | (32, 32, 512) | 0 | conv2d_13 |
| (UpSampling2D) | | | |
| conv2d_14 (Conv2D) | (32, 32, 256) | 524544 | up_sampling2d_2 |
| concatenate_2 | (32, 32, 512) | 0 | conv2d_6, conv2d_14 |
| (Concatenate) | | | |
| conv2d_15 (Conv2D) | (32, 32, 256) | 1179904 | concatenate_2 |
| conv2d_16 (Conv2D) | (32, 32, 256) | 590080 | conv2d_15 |
| up_sampling2d_3 | (64, 64, 256) | 0 | conv2d_16 |
| (UpSampling2D) | | | |
| conv2d_17 (Conv2D) | (64, 64, 128) | 131200 | up_sampling2d_3 |
| concatenate_3 | (64, 64, 256) | 0 | conv2d_4, conv2d_17 |
| (Concatenate) | | | |
| conv2d_18 (Conv2D) | (64, 64, 128) | 295040 | concatenate_3 |
| conv2d_19 (Conv2D) | (64, 64, 128) | 147584 | conv2d_18 |
| up_sampling2d_4 | (128, 128, 128) | 0 | conv2d_19 |
| (UpSampling2D) | | | |
| conv2d_20 (Conv2D) | (128, 128, 64) | 32832 | up_sampling2d_4 |
| concatenate_4 | (128, 128, 128) | 0 | conv2d_2, conv2d_20 |
| (Concatenate) | | | |
| conv2d_21 (Conv2D) | (128, 128, 64) | 73792 | concatenate_4 |
| conv2d_22 (Conv2D) | (128, 128, 64) | 36928 | conv2d_21 |
| conv2d_23 (Conv2D) | (128, 128, 2) | 1154 | conv2d_22 |
| conv2d_24 (Conv2D) | (128, 128, 1) | 3 | conv2d_23 |

| | |
|---|---|
| Total parameters | 31,032,837 |

### Training Results

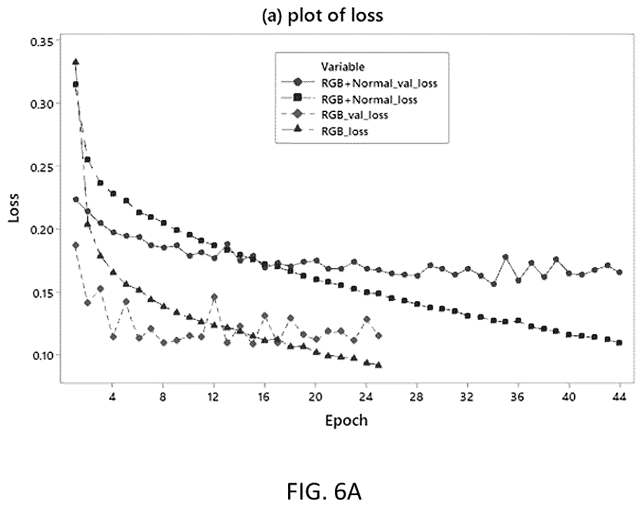

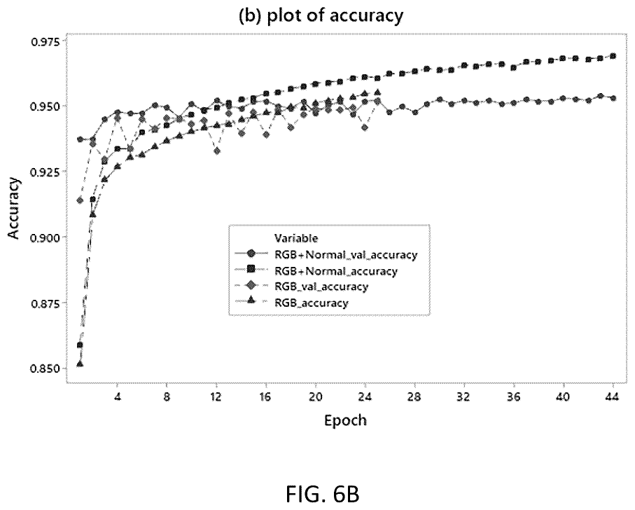

FIGS. 6A-6B shows the plots of loss (binary cross-entropy loss) of the U-Net training and validation process with two different types of datasets (RGB and RGB+Normal). The training of both models was stopped before the 100^{th}h epoch which avoided the model overfitting with the early stopping criteria of the validation loss has not been decreased for 10 epochs. In detail, the RGB model reached the smallest validation loss of 0.1083 at the 15^{th} epoch, and had an ending validation loss of 0.1151 at the 25^{th} epoch; the RGB+Normal model achieved the smallest validation loss of 0.1561 at the 34th epoch, and got an ending validation loss of 0.1653 at the 44th epoch.

Moreover, in FIGS. 6A-6B, the training and validation accuracy was measured by Keras “accuracy” which calculates how often predictions equal labels for the 128×128-pixel small-patches. With the additional 10 epochs training, the RGB model slightly increased the validation accuracy from 0.9478 to 0.9517, and the RGB+Normal model slightly improved the validation accuracy from 0.9521 to 0.9531. The results indicate the RGB+Normal model's validation accuracy is only slightly better than the RGB model. However, training the U-Net model with the RGB+Normal dataset (56,055 samples, 140 s/epoch in average, 44 epoches in total, and about 103 minutes) costs much more time than the RGB dataset (72,725 samples, 170 s/epoch in average, 25 epoches in total, and approximate 71 minutes). Since both models achieved satisfactory performance, with an accuracy over 0.95 in the end, the saved models at the ending epochs were used for testing and generating label prediction in this research.

### Testing Results

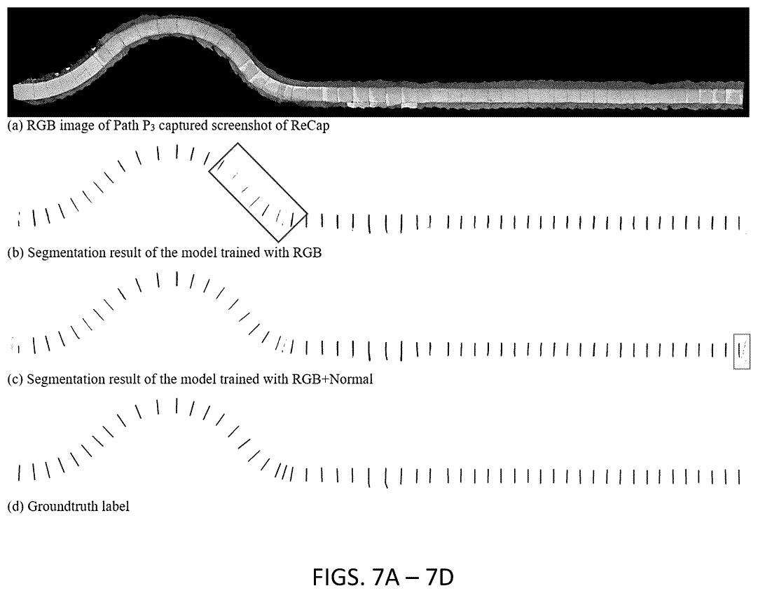

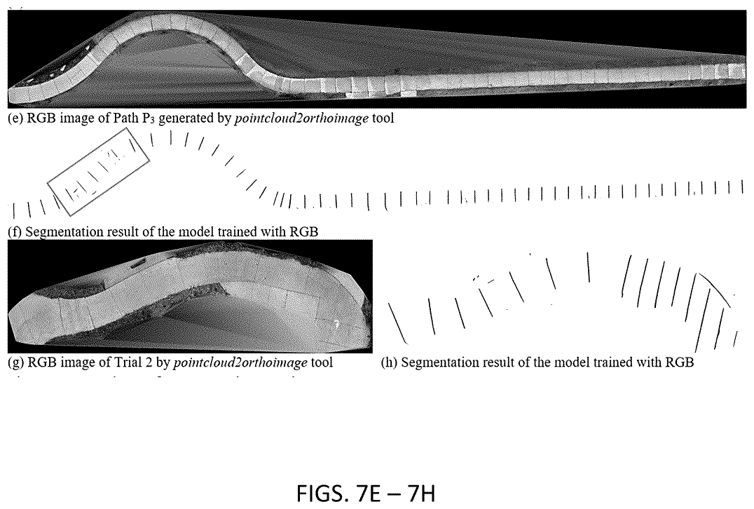

After training the models, data of the curved sidewalk path P₃ (see FIG. 7 (a), where joints are presented as oblique joints and different from training data sets of sidewalk path P₁ and P₂) and the south-north direction sidewalk path P₄ were used to test the well-trained RGB model and RGB+Normal model. Data of P₃ and P₄ were fed into the trained U-Net model, which then generated the 128×128-pixel small patch predictions. For example, FIG. 7A has dimensions of 3,456×512-pixel, which was disassembled into 371 small patches (because the width direction has 2×3,456/128−1=53 and the height direction contains 2×512/128−1=7 slide windows with a 64-pixel stride), then the U-Net model generated 371 output patches.

As the output patches were 50% overlapped with each other, only central parts of the output patches were assembled to obtain the large-sized segmented images, which were compared to the ground truth label images to evaluate the segmentation accuracy. Pixel accuracy, non-joint IoU (Intersection over Union) and joint IoU were used as the evaluation metrics. The evaluation results in Table 7 show that the model trained with RGB+Normal dataset performed slightly better than the model trained with only RGB dataset for all the four sidewalk paths. This conclusion is also supported by the validation accuracy plotted in FIG. 6B. The first two rows P₁ and P₂ in Table 7 indicate the U-Net model in sidewalk joint segmentation has better performance than the U-Net model in pavement cracking segmentation, which has an average pixel accuracy of 0.9817, average non-crack IoU of 0.9813, and average cracking IoU of 0.5728 in validation. In addition, in sidewalk joint segmentation, the integrated RGB+Normal feature is slightly better than the singular RGB feature because joints are straight lines with uniform normal features, while in pavement cracking segmentation, the singular RGB feature is better than the integrated RGB+Normal feature because cracks are irregular curves with more complicated normal features.

Additionally, Table 7 shows pixel accuracies obtained by the two models are similar when testing on each sidewalk path data. Similarly, there is only tiny or no difference of the non-joint IoUs for the two models. In contrast, relative larger differences were observed in joint IoUs obtained by the two models. In addition, both models always achieved the highest accuracy (in terms of all the three metrics) for segmenting the data of P₂ while the lowest for P₄ (in terms pixel accuracy and non-joint IoU) and P₃ (joint IoU). One possible reason for such results is that data of P₃ and P₄ are not included in the training dataset and the joints of P₃ are oblique joints which are different from those in P₁ and P₂.

TABLE 7
Evaluation results.

| | Pixel Accuracy | | Non-joint IoU | | Joint IoU | |
|---|---|---|---|---|---|---|
| Sidewalk | | RGB + | | RGB + | | RGB + |
| Path | RGB | Normal | RGB | Normal | RGB | Normal |
| P₁ | 0.9933 | 0.9955 | 0.9931 | 0.9954 | 0.7413 | 0.8163 |
| P₂ | 0.9958 | 0.9976 | 0.9957 | 0.9976 | 0.8112 | 0.8880 |
| P₃ | 0.9940 | 0.9941 | 0.9940 | 0.9940 | 0.5469 | 0.5517 |
| P₄ | 0.9896 | 0.9900 | 0.9894 | 0.9898 | 0.6658 | 0.6875 |

Furthermore, FIGS. 7B and 7C show the applied DA made the oblique joints in the curved section of sidewalk path P₃ detectable in the RGB and RGB+Normal models, respectively. The widths of the detected joints are smaller than the manually annotated label image (in FIG. 7D), which resulted in the smallest joint IoUs in Table 7 when testing the models on sidewalk path P₃. That is reasonable because the manually created label images used line segments with a constant width to represent all joints without considering the actual joint widths. Moreover, the geospatial resolution values of GSD are different among training and testing data sets, where the concrete slab widths (joint lengths) are about 72, 143, 66 and 96-pixel in sidewalk paths P₁, P₂, P₃ and P₄, respectively. The applied DA has randomly scaled ratios of (0.5, 2.5), which made the joint detectable in feature images with different GSDs. For future application, increasing the size of feature images (i.e., using a small GSD) to increase the number of joint pixels could be considered for improving performance of pixelwise segmentation.

Testing on Images Generated by the pointcloud2orthoimage Tool

The RGB images created by the pointcloud2orthoimage tool (FIGS. 7E and 7G) were processed by the well-trained RGB model with the disassembling and assembling algorithm. The image of FIG. 7E has dimensions of 8,539×1,128-pixel (GSD=1 cm/pixel), which was disassembled into 2,261 overlapped 128×128-pixel small-patches (because the image was padded into 8,576×1,152-pixel first, and then 2×8,576/128−1=133 columns and 2×1,152/128−1=17 rows, and a total of 2,261 small-patches were generated), and then the same number of 128×128-pixel U-Net output patches were used to assemble the image of FIG. 7G. The corresponding output segmented label image in FIG. 7F has dimensions of 8,539×1,128-pixel (GSD=1 cm/pixel), which are much larger than FIG. 7B-7D with dimensions of 3,456×512-pixel. The results show that the proposed deep learning-based image segmentation can process a very large sidewalk RGB image to produce pixelwise label image, in which all joints were well segmented, and several cracks were detected in FIG. 7F as well. Large cracks on concrete slabs would cause the trip hazards (see Table 1), while small cracks can be discarded by setting an area threshold in the joint extraction, as discussed later. Moreover, the label image prediction in FIG. 7H shows the segmentation model trained with RGB dataset successfully segmented sawcut joints that are perpendicular to concrete slab centerlines and skipped joints along centerline directions. Since the segmentation performances are very similar between the models trained with integrated RGB+Normal and singular RGB datasets as shown in Table 7, this paper used the U-Net model trained with RGB dataset for the remaining joint extraction tasks.

### Results of Joint Extraction and Vertical Displacement Measurement

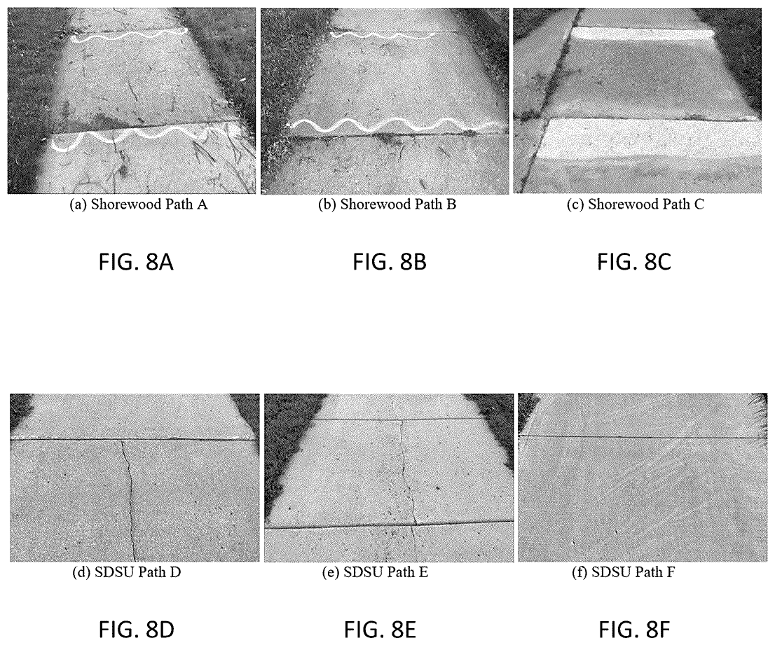

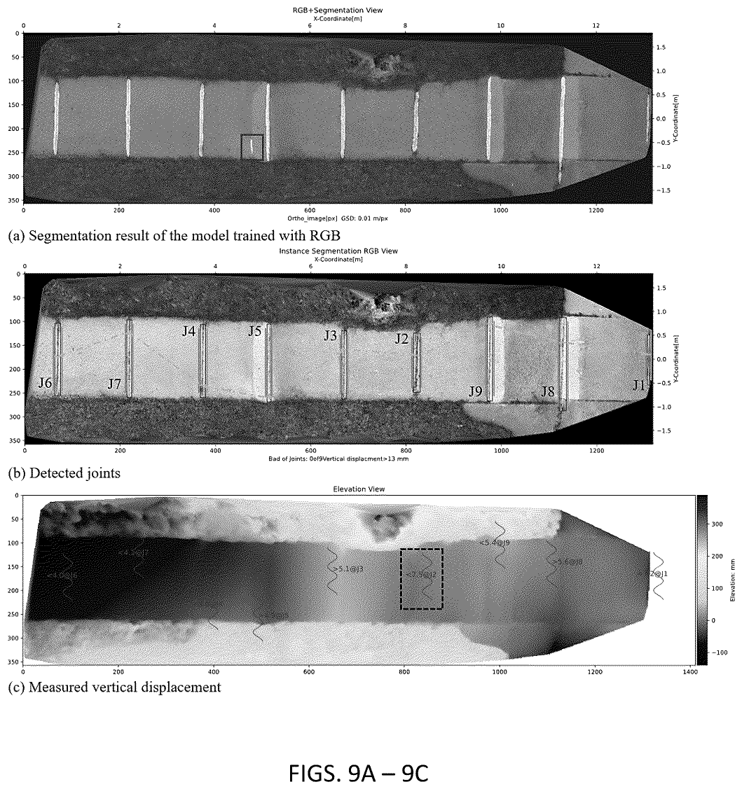

Typically, sidewalk concrete slab joints include contraction (control) joint, isolation (expansion) joint, and construction joint, which a width range from 3 mm to 20 mm with different construction methods and tools. The authors scanned additional old and new concrete sidewalks to test the developed joint extraction and vertical displacement measurement algorithm (in FIG. 3). First, two manually surveyed old sidewalk Paths A and B and one repaired (with grinding) sidewalk Path C were scanned (with resolution of 5 mm and other settings in Table 3) at the Shorewood Village in the USA. Shorewood Village conducted the sidewalk replacement program in the year of 2021, and the grinding eligible concrete slabs were marked with white wavy lines on the edges of the slabs if their vertical displacement is between 19.05 and 38.1 mm (¾ and 1½ inches), indicating the trip hazards, as shown in FIGS. 8A and 8B. In addition, three relatively new sidewalks (without marked trip hazards) with sawcut (FIGS. 8D and 8F) and concrete groover cut (FIG. 8E) contraction joints were scanned on the SDSU campus. The scanned point clouds were automatically converted into orthoimages and elevation data via the pointcloud2orthoimage tool with GSD=1 cm/pixel.

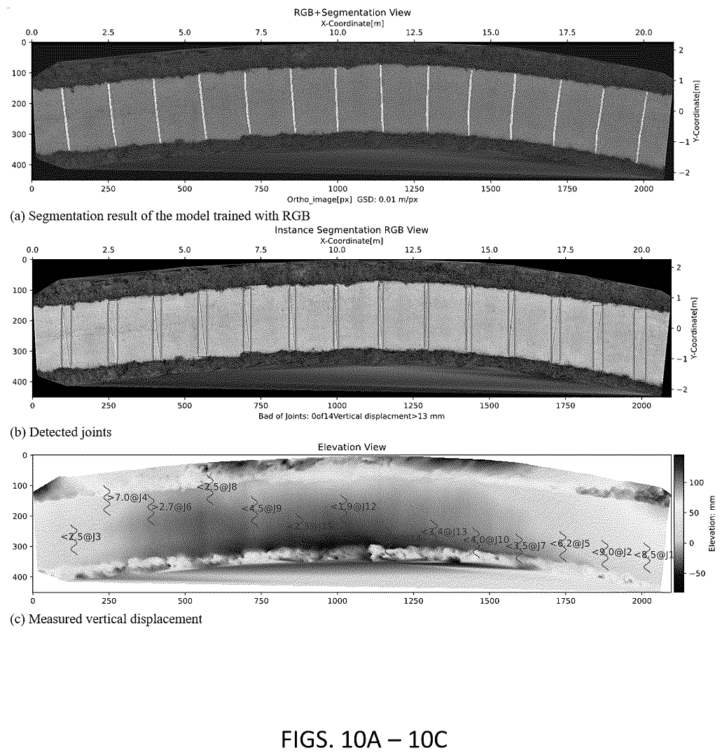

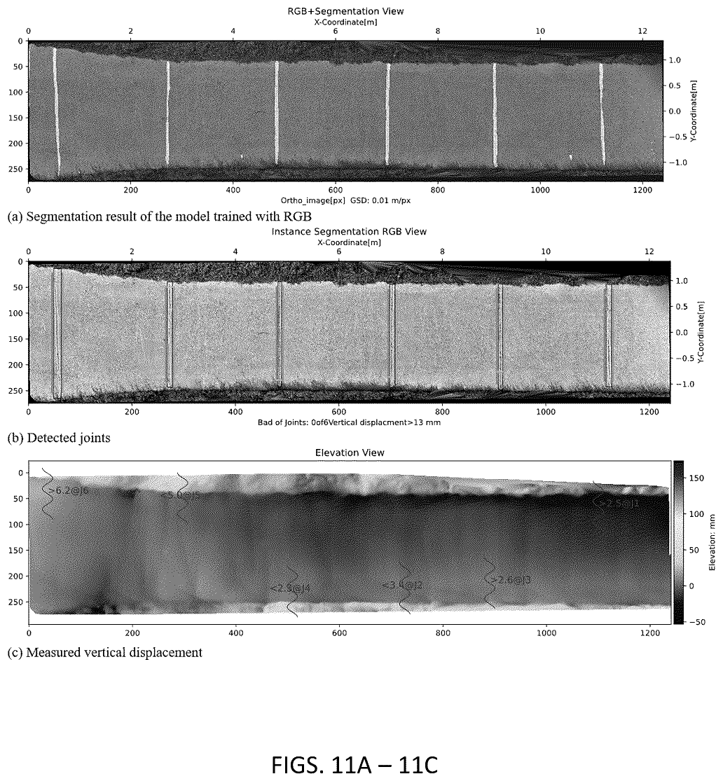

Moreover, FIGS. 10A-10C show the results (i.e. segmentation, extracted joints and vertical displacement) of a curved sidewalk Path E which is in good condition with groover cut contraction joints, and FIGS. 11A-11C show the same set of results of a newly constructed sidewalk Path F with sawcut contraction joints. Evaluation results show all concrete slabs in these two paths are in a good condition with vertical displacements less than 13 mm (½ inches).

### Experimental Results of Trip Hazard Sidewalks

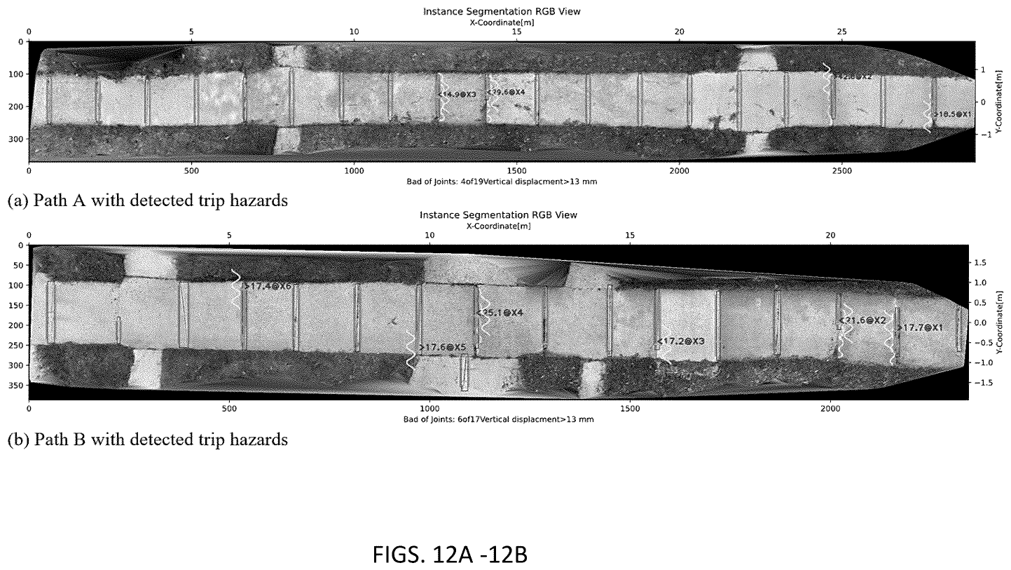

The grinding eligible sidewalk Paths A and B were evaluated, and results are shown in FIGS. 12A-12B. For sidewalk Path A in FIG. 12A, the developed method correctly identified four potential trip hazards, and the generated wavy lines match with the manually performed evaluation results in the same concrete slab edges. For sidewalk Path B in FIG. 12B, six trip hazards were identified, i.e., their vertical displacement exceeded the criterion of 13 mm. The largest three vertical displacement values occurred at X4, X2 and X1, and match with the manual evaluation results. Since Shorewood Village's policies (in Table 1) only identify vertical displacements larger than 19.05 mm (¾ inches), the other three identified joints with vertical displacements (17.2, 17.4, 17.6 mm) less than 19.05 mm were not marked on Path B. In FIGS. 12A and 12B, several extracted joints missed the parts where joints were covered by vegetation and dead leaves, as shown in FIGS. 8A and 8B. One potential approach to avoid that is to clean the sidewalk before scanning. Since the repaired sidewalk Path C is much cleaner than A and B, the joint extraction is better as well. Another approach is preparing additional joint label images for the covered conditions as labeling the joint label images is easier than labeling the point cloud.

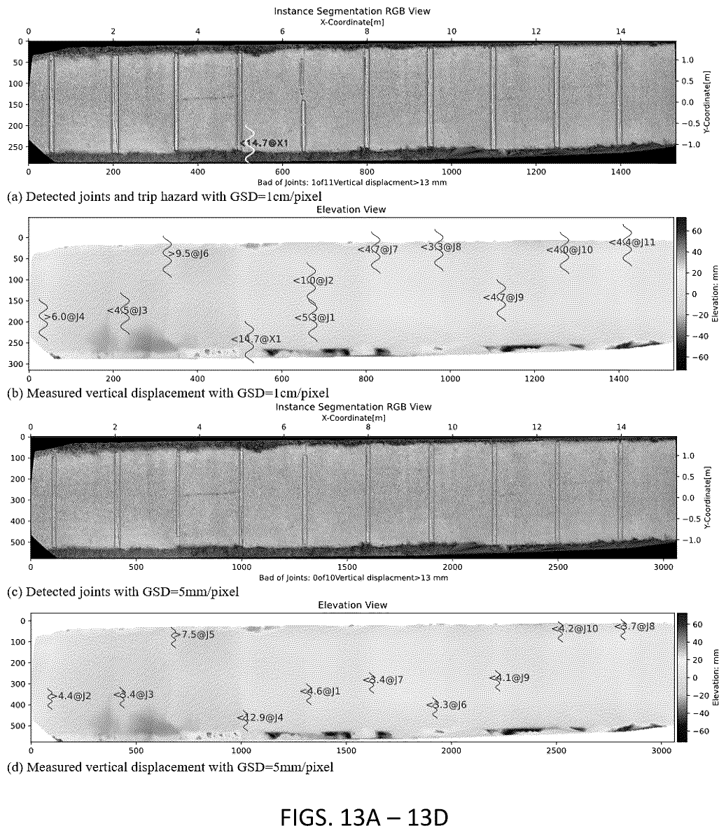

Furthermore, a trip hazard was successfully detected on the joint edge of Path D and annotated in FIG. 13A with a vertical displacement of 14.7 mm. The possible reason is that, FIG. 8D shows that only the concrete slab edge was grinded for Path D, and the repairing was not thoroughly performed as with path C in FIG. 8C. Moreover, a smaller GSD of 5 mm/pixel was tried to improve the pixelwise segmentation for Path D, in which the broken contraction joints were extracted as two separated joints in FIG. 13A. The developed pointcloud2orthoimage tool created a new RGB orthoimage in FIG. 13C, which has double the pixel size of the one in FIG. 13A. As a result, the broken contraction joints were extracted as a single joint in FIG. 13C. The maximum vertical displacement was slightly decreased from 14.7 mm to 12.9 mm, hence made the trip hazard disappear in FIG. 13C. However, this small difference is reasonable because: the edge offset parameter in Table 4 was not changed, the left slab edge (Xi=x−3) and right slab edge (Xi=x+w+3) are closer to the joint with the smaller GSD; then, the elevations of edges were measured on the grinded slope with a slightly smaller maximum vertical displacement.

### Long Path Trip Hazards Detection, Mapping and Geo-Visualization

The sidewalk joint segmentation and extraction results in Section 4.3 further confirmed the trained U-Net model with RGB dataset has good performances on the pointcloud2orthoimage tool generated RGB images. Those RGB images (GSD=1 cm/pixel) have the maximum width of 2,910-pixel, which is the longest (29.1-m) sidewalk Path A in FIG. 12A. In this section, SfM and LiDAR are compared for scanning long sidewalk paths, and the joint and trip hazard mapping is discussed later.

### Trip Hazards Detection of Long Paths Using SfM and LiDAR

As mentioned in Table 2, SfM photogrammetry is another alternative scanning method to obtain a sidewalk full-width as-is condition. To test the feasibility of the camera and SfM photogrammetry method, three trials of sidewalk scanning were conducted. In Trial 1, there were 1,136 images of a long singular walk path manually captured with a smart phone (Apple iPhone SE). The images were used to generate point cloud using a photogrammetry software (Pix4Dmapper) and SfM tool, VisualSFM. However, both methods failed to generate the point cloud file that continually represents the straight and flat sidewalk surfaces that have been scanned. Moreover, Pix4Dcatch (an application for ground 3D scans from mobile devices) was used to assist the sidewalk scanning in Trials 2 and 3.

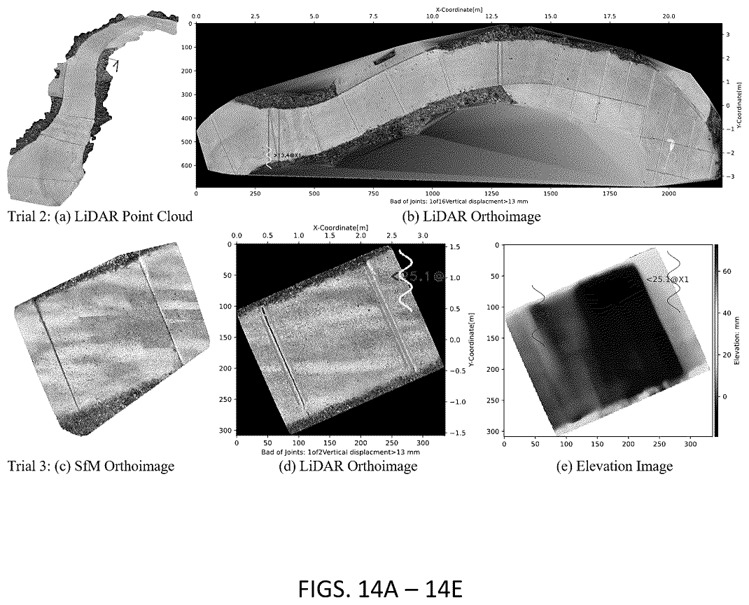

In Trial 2, a short sidewalk was walked twice (about 20 m) and obtained 100 images (with effective overlaps: 3.14 images per pair, GSD: 1.019 cm/pixel). The ReCap Photo took 65 minutes but only produced an area of 0.103 m² of point cloud. In contrast, the LiDAR point cloud scanned by iPhone Pro has full coverage of the short sidewalk, as shown in FIG. 14A. Following that, the created orthoimage (GSD=1 cm/pixel) from the LiDAR data, segmented image, and extracted joints are shown in FIG. 7G, FIG. 7H, and FIG. 14E, respectively. All joints perpendicular to sidewalk centerline were detected, joints across several concrete slabs were extracted as single long joints, while joints along centerline directions were skipped as per the design.

In Trial 3, two concrete slab joints were scanned and 100 images (effective overlaps: 4.37 images per pair, GSD: 1.001 cm/pixel) were obtained. The ReCap Photo took 61 minutes to generate the SfM photogrammetric point cloud with the orthoimage shown in FIG. 14C, which covers an area of 6.148 m² and the two concrete slab joints. The same joints were also scanned with an iPad Pro using built-in LiDAR sensor. FIGS. 14D and 14E show the LiDAR point cloud converted orthoimage and the elevation image, which have a GSD=1 cm/pixel. In Trial 3, the LiDAR and SfM method had equal scanning time, but the latter was much slower than former in converting images to textured point cloud. Thus, camera and SfM photogrammetry could be used for scanning a piece of trip hazard by property owners and concerned citizens, but for reporting a long sidewalk path, LiDAR would be a better option. According to the developed methods presented in this paper, the extracted joints and measurements of vertical displacements have the same length as the actual joints in FIGS. 14A-14E.

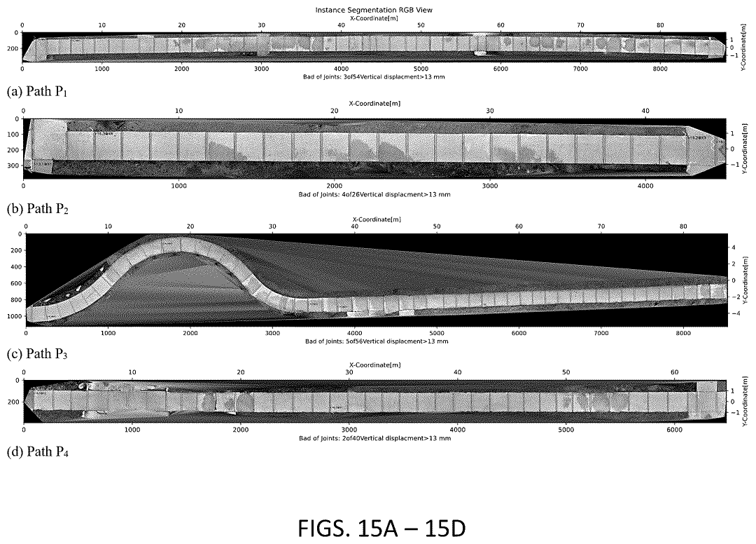

For scanning a long sidewalk path (like in FIG. 7E), which has an approximate length of 90 m along the sidewalk centerline, using a resolution of 10 mm is recommended, because the point cloud processing tool e.g. 3D Scanner App has limited storage for the point cloud file in a single scan. By setting GSD=1 cm/pixel, the point cloud converted elevation data is smooth without gaps. The point clouds of the four scanned long sidewalk paths P₁, P₂, P₃ and P₄ (see FIG. 5, concrete slab width about 1.8 m) were converted to feature images via the developed pointcloud2orthoimage tool with GSD=1 cm/pixel. All concrete slab joints were extracted, and vertical displacements were measured via the developed joint extraction and vertical displacement measurement algorithm. The created images of annotated trip hazards are shown in FIGS. 15A-15D, in which 54, 26, 56, and 40 joints were extracted, and three, four, five and two trip hazards were identified in paths P₁, P₂, P₃, and P₄, respectively.

### Mapping and Geo-Visualization of the Results in Web GIS

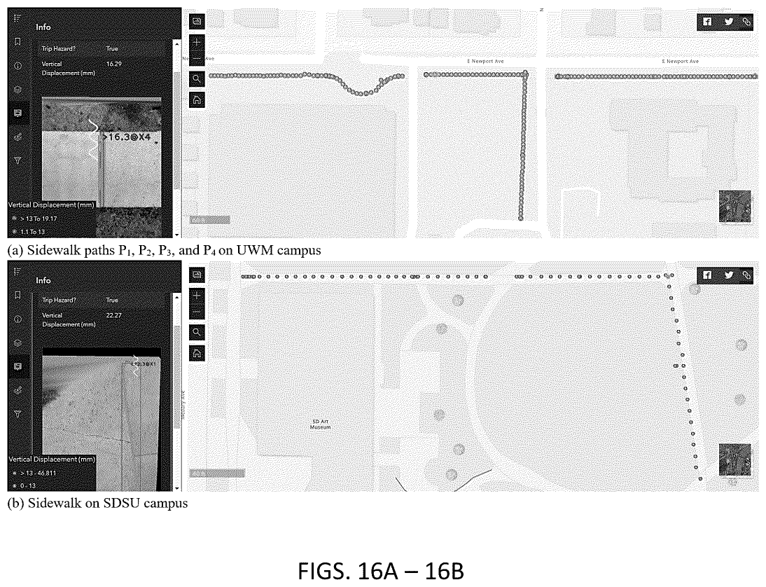

GPS coordinates of the start and end points of the four long paths were manually obtained from the Web GIS platform i.e., ArcGIS Online because they are corners and intersections. Based on the GPS coordinates of start and end points, the sidewalk Paths P₁ and P₂ belong to Case 1 (scanned from west to east), Path P₃ is Case 2 (scanned from east to west), and Path P₄ is Case 3 (scanned from south to north). The GPS coordinates of the middle points of each joint were calculated via Eq. (1) and the middle point was added to the Web GIS platform to represent the joint. Meanwhile, the joint segments were cropped from the annotated trip hazards images, and rotated zero degrees for Paths P₁ and P₂ (see FIG. 16A), rotated 180° for Path P₃ (see FIG. 4A), and rotated 90° for Path P₄ (see FIG. 4B). In the end, both the cropped joint image and specific displacement value were attached to each point of the joint in the Web GIS platform, as shown in FIGS. 16A-16B. This method can not only visualize and facilitate sidewalk assessment, but also help monitor and analyze the long-term sidewalk condition changes if scanning data are obtained continuously.

### CONCLUSION

This document describes a sidewalk trip hazard detection and geo-visualization method that can automatically assess concrete slab deficiencies after obtaining the point clouds via a low-cost LiDAR scanner. Firstly, low-cost mobile LiDAR devices were used to scan sidewalks to obtain the point cloud data, which were then converted to RGB images using the develop tool. Second, a deep learning-based segmentation model U-Net was trained with the sidewalk images to segment concrete joints in the image. Afterwards, joints were extracted from the segmented image and vertical displacements for each joint were evaluated, based on which potential trip hazards were identified and specific information was geo-visualized in Web GIS platform. The experiment results demonstrated the effectiveness of the proposed method. Specifically, the segmentation model performed well for segmenting different types of joints in images (with a highest joint IoU of 0.88) and all the vertical displacement conditions were accurately and comprehensively detected. It was found that integrating the RGB feature with the Normal feature can improve the joint segmentation accuracy of the deep learning model, but the improvement was not significant. In some examples, using the point cloud converted orthoimages is sufficient to detect joints. In this study, the segmentation model trained with a few images of straight sidewalks with groover cut contraction (control) joints and the corresponding joint label images already obtained good performance, but adding extra images, such as vegetation covered joints, to enrich the dataset can be implemented in some cases. Compared to the methods (in Table 2) in existing studies, scanning the as-is condition of the sidewalk with a mobile device is convenient and faster in achieving full-width coverage.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

1. The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for automated sidewalk deficiency detection, the method comprising:
obtaining, from a mobile device, a 3D point cloud of a sidewalk section, wherein the sidewalk section includes at least one slab joint;
converting the 3D point cloud into one or more elevation images;
segmenting, using a machine learning model, the slab joint from the elevation images;
determining, based on the segmenting, a vertical displacement of the slab joint; and
identifying a potential trip hazard based on the vertical displacement.

2. The method of claim 1, wherein obtaining the 3D point cloud comprises scanning the sidewalk section with a LiDAR scanner while a user carries the mobile device over the sidewalk section.

3. The method of claim 1, comprising converting the 3D point cloud into one or more 2D RGB ortho images.

4. The method of claim 1, comprising extracting at least a first joint from a straight segment of the sidewalk section and at least a second joint from a curved segment of the sidewalk section.

5. The method of claim 1, wherein determining the vertical displacement comprises measuring an elevation difference between two adjacent slab edges.

6. The method of claim 1, wherein obtaining the 3D point cloud comprises recording location information while obtaining the 3D point cloud, and wherein the method comprises mapping one or more identified trip hazards and one or more normal segments using the location information.

7. The method of claim 1, comprising aligning, using the 3D point cloud, a sidewalk surface to an XY plane and rotating a centerline to an X-axis.

8. A system for automated sidewalk deficiency detection, the system comprising:
a mobile device comprising one or more processors and memory storing instructions for the processors; and
an automated deficiency detector implemented on the one or more processors, the automated deficiency detector configured for performing operations comprising:
obtaining a 3D point cloud of a sidewalk section, wherein the sidewalk section includes at least one slab joint;
converting the 3D point cloud into one or more elevation images;
segmenting, using a machine learning model, the slab joint from the elevation images;
determining, based on the segmenting, a vertical displacement of the slab joint; and
identifying a potential trip hazard based on the vertical displacement.

9. The system of claim 8, wherein obtaining the 3D point cloud comprises scanning the sidewalk section with a LiDAR scanner while a user carries the mobile device over the sidewalk section.

10. The system of claim 8, the operations comprising converting the 3D point cloud into one or more 2D RGB ortho images.

11. The system of claim 8, the operations comprising extracting at least a first joint from a straight segment of the sidewalk section and at least a second joint from a curved segment of the sidewalk section.

12. The system of claim 8, wherein determining the vertical displacement comprises measuring an elevation difference between two adjacent slab edges.

13. The system of claim 8, wherein obtaining the 3D point cloud comprises recording location information while obtaining the 3D point cloud, and wherein the method comprises mapping one or more identified trip hazards and one or more normal segments using the location information.

14. The system of claim 8, the operations comprising aligning, using the 3D point cloud, a sidewalk surface to an XY plane and rotating a centerline to an X-axis.

15. A non-transitory computer readable medium comprising computer executable instructions embodied in the non-transitory computer readable medium that when executed by at least one processor of at least one computer cause the at least one computer to perform steps comprising:
obtaining, from a mobile device, a 3D point cloud of a sidewalk section, wherein the sidewalk section includes at least one slab joint;
converting the 3D point cloud into one or more elevation images;
segmenting, using a machine learning model, the slab joint from the elevation images;
determining, based on the segmenting, a vertical displacement of the slab joint; and
identifying a potential trip hazard based on the vertical displacement.

16. The non-transitory computer readable medium of claim 15, wherein obtaining the 3D point cloud comprises scanning the sidewalk section with a LiDAR scanner while a user carries the mobile device over the sidewalk section.

17. The non-transitory computer readable medium of claim 15, the steps comprising converting the 3D point cloud into one or more 2D RGB ortho images.

18. The non-transitory computer readable medium of claim 15, the steps comprising extracting at least a first joint from a straight segment of the sidewalk section and at least a second joint from a curved segment of the sidewalk section.

19. The non-transitory computer readable medium of claim 15, wherein determining the vertical displacement comprises measuring an elevation difference between two adjacent slab edges.

20. The non-transitory computer readable medium of claim 15, wherein obtaining the 3D point cloud comprises recording location information while obtaining the 3D point cloud, and wherein the method comprises mapping one or more identified trip hazards and one or more normal segments using the location information.
